(19) United States
(12) Patent Application Publication
(10) Pub. No.: US 2017/0021321 A1
(43) Pub. Date: Jan. 26, 2017

(54) GAS-SOLID REACTOR

(71) Applicant: CHEMICAL PROCESS ENGINEERING RESEARCH INSTITUTE CENTER FOR RESEARCH ANDTECHNOLOGY-HELLAS (CERTH-, Thessaloniki (GR)

(72) Inventors: Athanasios G. KONSTANDOPOULOS, Thessaloniki (GR); Dimitrios Dimitrakis, Thessaloniki (GR); Souzana Lorentzou, Thessaloniki (GR)

(73) Assignee: CHEMICAL PROCESS ENGINEERING RESEARCH INSTITUTE CENTER FOR RESEARCH AND TECHNOLOGY- HELLAS (CERTH-, hessaloniki (GR)

(21) Appl. No.: 15/286,066

(22) Filed: Oct. 5, 2016

Related U.S. Application Data
(63) Continuation-in-part of application No. 13/011,667, filed on Jan. 21, 2011, now Pat. No. 9,492,807.
Application No. 13/011,667 is a division of application No. 11/918,359, filed on Jan. 3, 2008, now abandoned.

(30) Foreign Application Priority Data
Apr. 14, 2005 (DE) 10 2005 017 216.4
Jul. 19, 2005 (EP) 05106614.0
Mar. 31, 2006 (EP) PCT/EP2006/061238

(51) Int. Cl. B01J 8/02

(52) U.S. Cl. CPC B01J 8/02; B01J 2208/021

(57) ABSTRACT

A reactor technology is disclosed for carrying out thermochemical processes namely splitting reactions of gas molecules fed into the reactor where at least one of the product species is temporarily stored within the reactor.

This application is a Continuation-In-Part of U.S. patent application Ser. No. 13/011,667 filed on Jan. 21, 2011 which is a divisional of U.S. patent application Ser. No. 11/918,359 filed on Jan. 3, 2008 which is a U.S. National Phase Stage Entry of International Application No. PCT/EP2006/061238 filed on Mar. 31, 2006 which claims priority to Application No. DE 10 2005 017 216.4 filed on Apr. 14, 2005 and Application EP 05106614.0 filed on Jul. 19, 2005.

### FIELD OF THE INVENTION

The present invention relates to gas molecules splitting methods and apparatus. More particularly, the invention relates to substantially splitting parent gas molecules into child species and to reactor technology for carrying out gas splitting reactions, where at least one of the child species is temporarily stored within the reactor.

### BACKGROUND OF THE INVENTION

The ever decreasing fossil fuel reserves, together with the increased concern on the environmental impact of their combustion to produce energy drives the need to discover new, clean and sustainable energy frameworks, including zero carbon and/or carbon neutral fuels and chemicals. A potential route is the splitting of inert gas molecules such as water (H₂O) and Carbon Dioxide (CO₂) employing mixed/doped oxide materials e.g. based on ferrite, rare earth and perovskite types, in reduction-oxidation cycles, powered by thermal sources, such as waste heat and/or the sun.

On a long-term basis, also hydrogen is an important carrier for a sustainable energy supply. Today, most of the hydrogen is prepared from fossil sources. However, the limited presence of these sources and the indispensable reduction of greenhouse gases (mainly CO₂) require the exploration of alternative resources or processes. Water splitting by means of electrolysis using solar current is possible, but has the disadvantage of an enormous influence of the cost of solar current on H₂ production. The direct utilization of concentrated solar radiation for thermochemical water splitting avoids this and has a higher efficiency. Thus, the cost of hydrogen production can be lowered and production on an industrial scale enabled on a long-term basis. Additionally, the utilization of carbon dioxide as a feedstock material for the solar-thermochemical production of synthesis gas creates the foundation for the reduction of carbon dioxide levels in the atmosphere and enables the carbon neutral production of synthesis gas.

A number of processes are available for the thermal production of hydrogen.

Thus, in DE 44 10 915 A1, hydrogen is produced by the reaction of iron with carbonic acid with supply of solar-thermal energy. The iron oxide formed is reduced again using carbon monoxide and is thus available for the process.

In DE 42 26 496 A1, hydrogen is produced in a modified continuous iron-water vapor process, and the iron oxide formed thereby is subsequently supplied to steel production again.

JP 03205302 A describes the preparation of highly pure hydrogen using activated magnetite as a reactive catalyst.

In JP 2001270701 A, hydrogen is prepared by reacting metallic zinc, magnetite and water at 600° C.

M. Inoue et al. in Solar Energy (2003) describes the preparation of hydrogen by means of a water-ZnO-MnFe₂O₄ system. The corresponding ferrite powder of the type Meₓ²⁺Zn₁₋ₓ²⁺Fe₂O₄ can be prepared by the method of S. Lorentzou et al. as presented on the conference Partec 2004.

According to a press communication by the Deutsches Zentrum für Luft- und Raumfahrt of Oct. 15, 2004, hydrogen was produced for the first time in a solar oven by solar-thermal water splitting. In the process described, the hydrogen is produced discontinuously by splitting the water vapor over metal oxide and regenerating the metal oxide.

DE 197 10 986 C2 describes a volumetric radiation receptor for heat recovery from concentrated radiation by heating a fluid under pressure without a chemical reaction occurring in this reactor. U.S. Pat. No. 8,480,923 B2 and U.S. Pat. No. 8,167,961 B2 both disclose methods for storing thermal energy, such as solar energy, as a fuel. U.S. Pat. No. 9,399,575 B2 provides a method and apparatus for gas-phase reduction oxidation.

### SUMMARY OF THE INVENTION

Thus, it is the object of the present invention to provide a reaction chamber for a process which can be performed without the need of solid separation. Said process shall proceed in a quasi-continuous manner at as low temperatures as possible.

The object of the present invention is in a first aspect solved by a gas-solid reactor body with multiple structured flow paths, locally parallel to and/or perpendicular and/or at an angle to the walls of the channels, enabling substantial reduction of composition gradients along the main direction of the flow as the solid material of the reactor undergoes oxidation and reduction processes reacting with gas species carried by the flow. Provided is thus a multichannel reactor with cross-flow paths in which the paths (or channels) are oriented parallel and/or perpendicular and/or at any other angle between 0° and 90° with respect to the walls of other channels.

In a further aspect, the invention relates to a reactor as of the first aspect wherein the solid material consists of from about 30% to about 100% in mass fraction of mixed/doped oxides obeying the general formula A_{w}BₓC_{y}Dₘ, where A, B, C and D are metal elements selected from the group of transition metals, rare earths, alkaline earths and post-transition metals, and the remaining solid material of from about 0% to about 70% being a thermally resistant ceramic of the oxide type or non-oxide type. The resistant ceramic of the oxide type may be alumina and/or magnesia based. Preferred examples for non-oxide type ceramics are carbides, nitrides, MAX phase materials and any other ultra-high temperature ceramics. The MAX phase materials are layered, hexagonal carbides and nitrides having the general formula: Mₙ₊₁AXₙ, (MAX) where n=1 to 3, M is an early transition metal, A is an A-group (mostly IIIA and IVA, or groups 13 and 14) element and X is either carbon and/or nitrogen as explained in Eklund, P., Beckers, M., Jansson, U., Högberg, H., & Hultman, L. (2010). “The Mn+1AXn phases: Materials science and thin-film processing”. Thin Solid Films. 518 (8): 1851-1878. doi:10.1016/j tsf.2009.07.184.

In a further aspect, the invention relates to a reactor as of the first aspect wherein its internal structure comprises thin porous elements with thickness of from about 0.1 mm to about 5 mm and/or porosity of from 10% to about 80%.

In a further aspect, the invention relates to a reactor as of the first aspect made by any of the following processes or combination of them: extrusion, casting, 3D printing/additive or subtractive manufacturing, robocasting, gel casting, tape casting. In principle, any known process is suitable but the above mentioned are preferred.

In a further aspect, the invention relates to a reactor as of the first aspect wherein one or more of the gas species is H₂O and/or CO₂.

### BRIEF DESCRIPTION OF THE DRAWINGS

FIG. 1 shows a schematic representation according to the present invention of the macroscopic gas flow (100) into the reactor body (150) which could have a cylindrical, rectangular or truncated conical shape, shown here only as examples and not restricting the invention's applicability to other shapes. FIG. 2 shows a schematic representation of the thin walls (200) and the local gas flow (300) occurring in the vicinity of said walls (200). The flow paths/channels/conduits are arranged in any convenient geometric multi-arrangement, known to those familiar with the art, including, but not limited to, straight, spiral, wavy, helical, zig-zag, and fractal configuration.

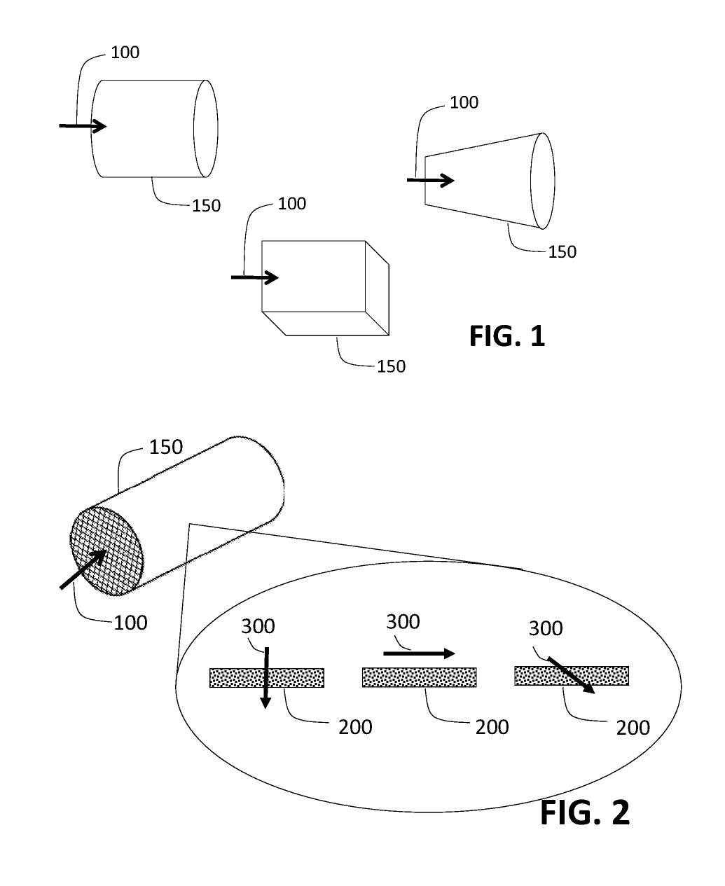

### DETAILED DESCRIPTION OF THE INVENTION

The object of the present invention is in a first aspect solved by a gas-solid reactor body with multiple structured flow paths, locally parallel to and/or perpendicular and/or at an angle to the walls of the channels, enabling substantial reduction of composition gradients along the main direction of the flow as the solid material of the reactor undergoes oxidation and reduction processes reacting with gas species carried by the flow. The flow paths (also described as channels in the following) can be oriented parallel to each other and/or perpendicular to each other and/or within an angle to the walls of the channels.

The reactor body of the invention is suitable for a process for the quasi-continuous performance of a chemical reaction consisting of at least two sequential reversible steps, characterized in that: at least two reaction chambers in each of which at least one reactant is locally fixed are operated in parallel, wherein

cyclically alternating reaction conditions are provided in the reaction chambers.

Locally fixed within the meaning of the invention means that the reactant is in a fixed position in the reactor and is preferably part of the reactor or a coating on a part of the reactor.

Sequential steps within the meaning of the invention are successive reaction steps of a chemical reaction in which the reaction products can be isolated.

Reversible steps within the meaning of the invention are reaction steps in which the chemical equilibrium can be adjusted in such a way that alternatively either the forward or the backward reaction preferably proceeds.

A chemical reaction within the meaning of the invention is in principle any chemical reaction in which one of the reactants is fixed and in which the energy is supplied as heat energy, light energy, nuclear energy or in the form of other electromagnetic radiation. Preferably, the process according to the invention is employed in the following reaction types listed in an exemplary manner:

| Reaction | | |
|---|---|---|
| type | First step | Second step |
| H₂ | MeOₓ + H₂O → H₂ + MeO_{y} | MeO_{y} → MeOₓ + O₂ |
| production | | |
| Reduction of | MeOₓ + CO₂ → MeO_{y} + CO | MeO_{y} → MeOₓ + ½ O₂ |
| carbon | | |
| dioxide | | |
| Cleavage of | MeOₓ + NOₓ → MeO_{y} + | MeO_{y} → MeOₓ + ½ O₂ |
| nitrogen | ½ N₂ | |
| oxides | | |
| Cleavage | MeOₓ + SO₃ → MeO_{y} + SO₂ | MeO_{y} → MeOₓ + ½ O₂ |
| of SO₃/ | | |
| production | | |
| of SO₂ | | |
| Selective | MeOₓ + O₂ → MeO_{y} | CₘHₙ + MeO_{y} → MeOₓ + |
| oxidation | | CₘHₙO |
| Dehydro- | MeOₓ + O₂ → MeO_{y} | CₘHₙ + MeO_{y} → MeOₓ + |
| genations | | CₘHₙ₋₂ + H₂O |
| H₂ | Me + H₂O → H₂ + MeO | MeO → Me + ½ O₂ |
| production | | |
| H₂ | MeX_{y} + HX → MeX_{y+1} + | MeX_{y+1} → MeX_{y} + ½ X₂ |
| production | ½ H₂ | |

In this table, Me represents a metal atom, X represents a halogen or pseudohalogen, subscripts n, m, x or y represent positive integers.

In the process according to the invention, throughout the reaction time of a first sequential step of a chemical reaction in a first reaction chamber, a second sequential reaction step other than said first sequential reaction step proceeds at least one time in a second reaction chamber, which is different from the first. Thereby, it is achieved that the final product can be provided by the process at any time and the reaction chambers are utilized optimally.

Since the different sequential reaction steps can have a different reaction time, for optimally utilizing the capacity of the reaction chambers, advantageously:

a) the energy input in the reaction chambers can be selected differently to adjust the reaction rates;

b) the mass flow of the reactants can be adjusted; and/or c) the number of reaction chambers can be adjusted in accordance with the reaction times in which the reactions proceed in a corresponding time-shifted mode.

The latter variant meaning that in case of several reaction chambers the reactions in each chamber are out of phase with each other.

In the process according to the invention, all reversible reaction steps of the chemical reaction are preferably performed sequentially in the same reaction chambers. Thus, separation or isolation of intermediate products can be dispensed with.

Advantageously, in the invention, radiation-heated reactors are employed as reaction chambers for the above described process. Thus, thermal reactions can be performed with light energy. Any electromagnetic radiation can be employed as the radiation. According to the invention, photoreactions may also advantageously take place when the process is performed. Reactions that are thermal in principle may also proceed in a photoassisted manner, in particular, according to the invention. “Photoassisted” within the meaning of the invention means that the reaction product is formed with enhancement by a photoreaction.

Said cyclically alternating reaction conditions are preferably provided by cycling the temperature of the reaction chambers, for example, by varying the heating power.

More preferably, the required temperature in the reaction chambers is varied by periodically changing the heating power to enable a quasi-continuous product stream. For example, the different thermal addressing of the reactors enables simultaneous reactions of water and/or carbon dioxide splitting at a lower temperature and regeneration at a higher temperature. Thus, the sequence of these different batch processes enables a quasi-continuous production of hydrogen and/or carbon monoxide, for example.

Advantageously, the process is performed in several successive cycles is a quasi-continuous reproducible way. For example, one cycle takes a period of time within a range of from 0.3 to 1.5 hours, especially from 0.3 to 1 hour. Over a discontinuous process, this has mainly economical advantages. However, depending on the reaction to be performed, the cycles may also be substantially shorter or longer.

In accordance with the different energy requirements of the reactions concerned to be performed sequentially, it is further preferred in this process to set the cycling of the temperature of the fixed reactant (for example, the metal oxide) by varying the heating power, for example, because the splitting is to take place first followed by regeneration.

It is advantageous if the absorbed energy of the optical component (preferably an attenuator) is utilized for heating fluids. Such fluids may be, inter alia, reactants, auxiliary agents or heat transfer media. Being preheated, the fluids do not require that much radiated power in the reactor space any more. It is particularly preferred if the optical component is a tube bundle flowed through by the fluid.

In the process according to the invention, fossil energy, electric energy, light energy and/or nuclear energy is preferably employed.

Preferably, the required temperature can be generated by burning fossil energy carriers and/or utilizing electric energy, because usual processes utilize these energy sources.

It is also advantageous to generate the required temperature by nuclear energy because in nuclear reactions only about one third of the heat produced in the reactor can be utilized for electric power production. The (residual) heat produced can be utilized for generating the required temperature. On an industrial scale, no climate-damaging emissions of CO₂ are formed thereby.

Advantageously, however, the energy input takes place by light energy, especially by concentrated solar radiation, because this energy source is available at particularly low cost and is suitable for both thermal and photoreactions alike.

The generation of the required temperature by means of light energy is advantageous, because conventional energy-producing systems burning fossil energy carriers are not as resource efficient as the process according to the invention, and light energy, such as sunlight, is available worldwide.

Preferably, sunlight can be irradiated into the reaction chamber by means of optical set-ups in order to generate the required temperature. Such optical set-ups have particularly preferred manifestations, such as solar tower systems, paraboloid concentrators, sun ovens, elliptical or spherical mirrors or line-focusing concentrators. By means of solar-thermochemical water splitting, hydrogen can thus be produced on an industrial scale as a possible energy carrier of the future without climate-damaging emissions of carbon dioxide.

The required radiated power is preferably achieved by a group of heliostats, and the radiated power required for regeneration is achieved by another group of heliostats, the focus of the second group being rearranged onto the individual reaction fields. The heliostat array is separated in such a way that at least one group of heliostats covers the base load of the necessary radiated power in accordance with the reaction step with the lowest energy requirement by being “regularly” tracked in accordance with the daily course of the sun, and that at least one group of heliostats covers additional loads of necessary radiated power for reaction steps with an increased energy requirement by guiding the focus of this group to another area of the radiation receptor at defined intervals respectively after completion of the respective reaction step. By this method, two different reaction temperatures can be easily realized.

Advantageously, the reaction chambers are shifted relative to the radiation source in order to vary the heating power. A temperature change can be effected uncomplicatedly thereby while maintaining the radiated power. Thus, the reaction chambers can preferably be changeable relative to the optical set-up in order to vary the heating power. A temperature change can be effected uncomplicatedly thereby while maintaining the radiated power.

For varying the solar-thermal heating power, the use of optical components is advantageously suitable for reducing the irradiation. More particularly, optical attenuators, apertures, deflector mirrors or filters that can be shifted in space or are variable in terms of transparency are suitable for this.

This may be advantageously achieved, inter alia, by varying the focal position due to a change in the orientation of mirrors or mirror arrays, so-called heliostat arrays. This can be realized substantially more easily than the shifting of the reactor, which is mostly very heavy.

Preferably, a temperature within a range of from 500° C. to 1000° C., especially up to 900° C., is set in a first reaction chamber, and a temperature within a range of from 1000° C. to 1400° C. is set in a second reaction chamber, in order to perform, for example, the hydrogen and carbon monoxide production at a particularly low temperature in a first reaction chamber and simultaneously the regeneration at a higher temperature in a second reaction chamber. However, depending on the reaction to be performed, the temperatures employed may also deviate substantially from these values.

The fixed reactant in the two reaction chambers (reactor bodies) is advantageously selected from the group of metal hydrides, dyes, chemical compounds having redox properties, and complexing agents. Chemical compounds having redox properties within the meaning of the invention are those compounds that can be reversibly oxidized and reduced. Advantageously, these chemical compounds having redox properties are selected from the group of metal oxides, mixed metal oxides and/or doped metal oxides. Of these reactants, metal oxides have proven particularly advantageous because they are most versatile to employ and can be particularly easily fixed, for example, in contrast to metal hydrides.

More preferably, a multivalent metal oxide is employed as a fixed reactant because it can be fixed and regenerated particularly easily. “Multivalent” within the meaning of the invention means a metal oxide having several coexisting oxidation states, especially if the metal is in an oxidation state of more than +1, especially more than +2.

Some illustrative but not restrictive examples of metal oxides are NiFe₂O₄, CoFe₂O₄, CuFe₂O₄, MnFe₂O₄, ZnFe₂O₄, NiₓZn_{y}Fe₂O₄, MnₓZn_{y}Fe2O4, FeAl₂O₄, CuAl₂O₄, (Cu,Fe)Al₂O₄, (Co,Fe)Al₂O₄, Gd₃Fe₅O₁₂, La_{0.5}Sr_{0.5}FeO₃, CeₓZr_{y}O₂, where x+y=1, and preferably, the metal oxides include:
(a) substituted ferrites of the general formula MeₓFe₃₋ₓO₄ wherein Me is one or more ions selected from the group of Bi, Mg, Ca, Mn, Fe, Co, Ni, Cu, Zn, Sr, Sn, Ba, Cd, Pb, Zr, Ce, La, Yt, Gd, Hf, Al, Mo, Nb, Ti, V and/or rare earths (lanthanides), wherein x is a number in the range of from 0 to 3. and/or
(b) Pure, mixed/doped cerium oxides of the general formula MeₓCe₁₋ₓO₂ wherein Me is one or more ions selected from the group of Bi, Mg, Ca, Mn, Fe, Co, Ni, Cu, Zn, Sr, Sn, Ba, Cd, Pb, Zr, La, Yt, Gd, Hf, Al, Mo, Nb, Ti, V and/or rare earths (lanthanides), wherein x is a number in the range from 0 to 1, and/or
(c) perovskite oxides of the general formula ABO₃, wherein, A and B are ions selected from the group of Bi, Mg, Ca, Mn, Fe, Co, Ni, Cu, Zn, Sr, Sn, Ba, Cd, Pb, Zr, Ce, La, Yt, Gd, Hf, Al, Mo, Nb, Ti, V and/or rare earths (lanthanides) and/or
(d) Ruddlesden-Popper phases, with a general formula Aₙ₋₁A′₂BₙX₃ₙ₊₁, where A, A′, and B are cations, X is an anion (preferably O) and n can take integer values larger than 1 (preferably from 1 to 3). A and A′ represent alkali, alkaline earth, or rare earth metals while B refers to a transition metal, with some illustrative but not restrictive examples being with some examples being LaₓSr₁₋ₓMO₃ (M=Mn, Co, Fe), BaₓSr₁₋ₓ,(Co,Fe)O₃, LaSrCoO₄, and LaSrFeO and/or
(e) mixtures of the above (a)-(d) oxides.

because these can be employed particularly efficiently in hydrogen and carbon dioxide splitting.

Advantageously, the chemical compound having redox properties can be employed as a coating of a heat-resistant support structure, more preferably a ceramic one. Due to the use of a support structure, the chemical compound having redox properties need be in the reaction chambers only in a thin layer.

Preferably, a support structure having a conical, hemispherical or paraboloid shape is employed because scattered radiation from the radiation source can be optimally utilized in the reaction chamber thereby.

In addition to the fixed reactants, mobile reactants may also be employed.

In the process according to the invention, at least one of the mobile reactants is advantageously selected from the group of water, alcohols, carbon dioxide, hydrogen sulfide, nitrogen oxides, hydrocarbons, halo- or pseudohalohydrocarbons, ammonia and sulfur oxides. Of these mobile reactants, water and carbon dioxide have proven to be particularly advantageous because they are readily available and easily handled reactant, above all in the gas phase.

Further, at least one, more preferably all mobile reactants in the process or reactants can be transferred to the reaction chambers particularly easily. In addition, preferably at least one and more preferably all mobile reaction products are gaseous, because it is equally easy then to extract them from the reaction chambers.

Therefore, the reactor body is advantageously suitable for a process for producing hydrogen from water vapor and carbon monoxide from carbon dioxide on a surface of at least one chemical compound having redox properties, wherein:

in the first step, water vapor and/or carbon dioxide is split by associating oxygen to the excited chemical compound having redox properties to release hydrogen and/or carbon monoxide; and in the second step, the chemical compound having redox properties is regenerated at a temperature which is higher than that of the first step to release bound oxygen.

Thus, the invention relates further to a process of splitting water vapor and/or carbon dioxide thermally in a multi-step process by using concentrated radiation and thus producing solar hydrogen and solar carbon monoxide or when the reactants are fed to the reactor simultaneously solar synthesis gas.

With the process according to the invention, water vapor and carbon dioxide can be thermally split by concentrated sunlight to produce hydrogen, carbon monoxide and their combination, i.e. solar synthesis gas. This is the basis for developing the process according to the invention with which hydrogen/carbon monoxide and/or synthesis gas can be produced by a solar-thermal process. In contrast to direct thermal water splitting or direct thermal carbon dioxide splitting, which take place over two thousand degrees centigrade, hydrogen and carbon monoxide are produced here from water vapor and carbon dioxide in a two-step cycle process, preferably at temperatures within a range of from 900° C. to 1600° C. What is recirculated, for example, is a metal oxide system that can cleave oxygen from water molecules and carbon dioxide molecules and reversibly bind it into its crystal structure.

MeO_{red}+H₂O→MeOₒₓ+H₂ Reaction 1A: Splitting

MeO_{red}+CO₂→MeOₒₓ+CO Reaction 1B: Splitting

MeOₒₓ→MeO_{red}+O₂ Reaction 2: Regeneration

Preferably, metal oxides (MeO) with different doping are employed and are cyclically oxidized and reduced. In the first step, the hot water vapor and or a carbon dioxide stream flowing past the metal oxide are split by binding the oxygen to the excited metal oxide lattice at temperatures preferably within a range of 500to 1200° C., to release hydrogen and/or carbon monoxide. In the second step, the oxygen previously incorporated into the lattice is released again at temperatures preferably within a range of from 800to 1600° C., and the metal oxide is regenerated or reduced again to the high-energy state. These temperatures preferably apply to substituted ferrites or pure mixed/doped cerium oxides or perovskites or Ruddlesden-Popper phases. More preferably, the reaction temperature may advantageously be within a range of from 600° C. to 1100° C., and the regeneration temperature may be within a range of from 1000° C. to 1500° C. Thus, all in all, water and/or carbon dioxide are split into their elements by means of the metal oxides. The metal oxides employed are advantageously mixed oxides, more preferably substituted ferrites, or pure mixed/doped cerium oxides or perovskites or Ruddlesden-Popper phases.

One important innovation of the process is the advantageous combination of a ceramic support and absorber structure that can be heated at high temperatures with concentrated solar radiation, with a redox system that is capable of reversibly splitting water or carbon dioxide, for example. Preferably, porous honeycomb structures functioning as radiation absorbers are coated with an active material, e.g. ferrites. This includes advantages over comparable processes since the complete process can be performed in a single converter here. Thus, solids need not be circulated, and because the oxygen binds to the metal oxide, the product separation is reduced to one gas separation. In addition, this system enables the splitting process to be performed at clearly lower temperatures that can be mastered in terms of material technology. Preferably, the metal oxide is recycled, so that only water/carbon dioxide is consumed. All these technical advantages also offer economical advantages over other processes for hydrogen/carbon monoxide/synthesis gas production.

The ceramic structure coated with metal oxide advantageously forms the core of a receiver reactor. By being coupled to a concentrating solar plant (preferably a solar tower), the structure is brought to the necessary temperature by the incident concentrated solar radiation. The reactions take place on the surface of the coated ceramics. The reactor is preferably integrated in a small plant for checking and optimizing the operational behavior during splitting or regeneration. This plant preferably comprises fittings and mass flow controllers for supplying the necessary gases, a water vapor dosing system, a carbon dioxide flow controlling system, measuring systems for pressure and temperature, product gas treatment, and data acquisition and control. The analysis of the concentrations of produced hydrogen and carbon monoxide or released oxygen is preferably effected by a mass spectrometer.

For an efficient utilization of the reactor, it is preferably required that a continuous operation for obtaining the product (hydrogen or carbon monoxide or a combination thereof) can take place. Since two steps with different conditions are to be performed, a cyclic change of the reaction conditions or gases and of the required energy (temperature) must be effected.

Preferably, the water vapor and carbon dioxide are split at a temperature within a range of from 500° C. to 1200° C., especially from 600 to 1100° C., and the metal oxide is regenerated at a temperature within a range of from 800° C. to 1600° C., especially from 1000 to 1500° C. To date, it has been necessary to employ temperatures of a few thousand degrees, but at least 2000° C., for one-step thermal water splitting. The lower temperature range is more easily handled in terms of materials and process technology and significantly reduces the cost of the process.

Therefore, the object of the invention is preferably achieved by a process for the quasi-continuous production of hydrogen from water vapor and of carbon monoxide from carbon dioxide on a surface of a metal oxide followed by regeneration of the surface.

For the quasi-continuous production of synthesis gas from water vapor and carbon dioxide, on a surface of a metal oxide followed by regeneration of the surface, it is advantageous if a quasi-continuous synthesis is performed in at least two reaction chambers, whereby water vapor and carbon dioxide can be co-fed to the reactor, converted to hydrogen and carbon monoxide, and simultaneously another reaction chamber can be regenerated in order to convert water vapor and carbon dioxide to hydrogen and carbon monoxide again immediately afterwards. This quasi-continuous process can substantially simplify the thermal production process of synthesis gas.

Thus, in the process according to the invention, advantageously the synthesis gas production by water and carbon dioxide splitting can take place in one reactor while the regeneration of the metal oxide takes place in another. In the subsequent cycle, the regenerated reaction chamber can then take up new reactants again. Thus, the thermal production of synthesis gas can be effected continuously and simply as compared to the prior art.

In another embodiment, the object of the invention is achieved by a thermal process for the preparation of hydrogen and/or carbon monoxide and/or synthesis gas from water vapor and carbon dioxide on a surface of a metal oxide in a gas/solid phase reaction, wherein in a reaction chamber, in a first step, water vapor and/or, possibly simultaneously, carbon dioxide are split by associating oxygen to the excited metal oxide to release hydrogen and carbon monoxide, and in a second step, the metal oxide is regenerated at a temperature which is higher than that of the first step to release bound oxygen, so that the metal oxide is available for further reactions.

Thus, the invention relates to a process for thermally splitting water vapor and carbon dioxide in a multistep process by utilizing concentrated radiation and thus to produce solar hydrogen, solar carbon monoxide and solar synthesis gas.

In a further embodiment, the object of the invention is achieved by a photoreactor for performing the process according to the invention, characterized by having two reaction chambers.

In a still further embodiment, the object of the invention is achieved by a radiation-heated reactor for performing the process according to the invention, characterized by having two reaction chambers.

This reactor is preferably a reactor for the thermal preparation of synthesis gas from water vapor and carbon dioxide on a surface in a gas/solid phase reaction comprising at least one connected tube that enables a gas stream of educt gases to flow into a reaction chamber (reactor body) and of product gases to flow out, and a heat source, metal oxide being provided as a reactant in one reaction chamber.

Preferably, the metal oxide is coated on a heat-resistant ceramic support structure in the reactor. This fixation has the advantage that the metal oxide is always available and thus can be exposed to the heat source optimally in the reactor. Due to the fixation of the metal oxide on the support structure, the metal oxide need not be recovered tediously by separation processes. Advantageously, the heat necessary for the reactions can also be supplied out of the support structure.

The reaction chamber is advantageously provided with a transparent window because the light source can be arranged outside the actual reactor in this way.

Advantageously, tubes that attenuate the energy flow run between the reaction chamber and energy source, because this enables a better control of the reaction.

Preferably, the tubes contain a fluid because the heat exchange can be adjusted individually thereby.

The reactor is advantageously provided with a multiport valve to enable the supply of the gaseous educts.

Preferably, the multiport valve has such a design that the gaseous products can be removed separately.

Advantageously, the reactor has a modular structure consisting of at least two reaction chambers, because the quasi-continuous process described above can be implemented particularly easily thereby.

Preferably, the two reaction chambers (reactor bodies) are alternately provided with water vapor/carbon dioxide or inert gas, especially nitrogen, the switching being effected in such a way that a hydrogen and/or carbon monoxide production constant in time is provided.

Preferably, the metal oxides include:
(a) substituted ferrites of the general formula MeₓFe₃₋ₓO₄ wherein Me is one or more ions selected from the group of Bi, Mg, Ca, Mn, Fe, Co, Ni, Cu, Zn, Sr, Sn, Ba, Cd, Pb, Zr, Ce, La, Yt, Gd, Hf, Al, Mo, Nb, Ti, V and/or rare earths (lanthanides), wherein x is a number in the range of from 0 to 3. and/or
(b) pure or doped cerium oxides of the general formula MeₓCe₁₋ₓO₂ wherein Me is one or more ions selected from the group of Bi, Mg, Ca, Mn, Fe, Co, Ni, Cu, Zn, Sr, Sn, Ba, Cd, Pb, Zr, La, Yt, Gd, Hf, Al, Mo, Nb, Ti, V and/or rare earths (lanthanides), wherein x is a number in the range from 0 to 1, and/or
(c) perovskite oxides of the general formula ABO₃, wherein, A and B are ions selected from the group of Bi, Mg, Ca, Mn, Fe, Co, Ni, Cu, Zn, Sr, Sn, Ba, Cd, Pb, Zr, Ce, La, Yt, Gd, Hf, Al, Mo, Nb, Ti, V and/or rare earths (lanthanides) and/or
(d) Ruddlesden-Popper phases, with a general formula Aₙ₋₁A′₂BₙX₃ₙ₊₁, where A, A′, and B are cations, X is an anion (preferably O) and n can take integer values larger than 1 (preferably from 1 to 3). A and A′ represent alkali, alkaline earth, or rare earth metals while B refers to a transition metal, with some illustrative but not restrictive examples being with some examples being LaₓSr₁₋ₓMO₃ (M=Mn, Co, Fe), BaₓSr₁₋ₓ,(Co,Fe)O₃, LaSrCoO₄, and LaSrFeO and/or
(e) mixtures of the above (a)-(d) oxides.

Advantageously, a concentrating solar-thermal system, such as a solar tower system, a paraboloid concentrator, a sun oven, an elliptical or spherical mirror or a line-focusing concentrator, is employed as the energy source.

Preferably, the required radiated power is achieved by a group of heliostats, and the radiated power required for regeneration is achieved by another group of heliostats, the focus of the second group being rearranged onto the individual reaction fields.

In the following, an Example of the invention, is further illustrated by means of Figures. This Example is not to be understood as limiting the scope of protection of the invention.

The process according to the invention for solar-thermochemical water and carbon dioxide splitting on the basis of metal oxides for continuous hydrogen/carbon monoxide/synthesis gas production can be performed continuously by means of the design of an appropriate receiver reactor as described herein.

Said process is enabled by a reactor with a geometry as described in the present invention. Provided is thus a multichannel reactor with cross-flow paths in which the paths are oriented parallel and/or perpendicular and/or at any other angle between 0° and 90° with respect to the walls of other channels. The specific geometry enables a substantial reduction of composition gradients along the main direction of the flow as the solid material of the reactor undergoes oxidation and reduction process reacting with gas species carried by the flow.

The material of the paths may be porous. It may comprise or preferably consist of porous elements (thin walls) with a porosity of from about 10% to about 80%. The thickness of the elements is preferably from about 0.1 mm to about 5 mm.

The active material of the paths can be selected from any of the following list: substituted ferrites, pure mixed/doped cerium oxides, perovskites or Ruddlesden-Popper phases. Some particular but non-limiting examples are NiFe₂O₄, CoFe₂O₄, Zr_{0.25}CeO₂, Hf_{0.25}CeO₂, LaSrO₃, etc.

The solid material comprises of from about 30% to about 100% in mass fraction, and the remaining solid material of from about 0% to about 70% being a thermally resistant ceramic of the oxide type or non-oxide type. The resistant ceramic of the oxide type may be alumina and/or magnesia based. Preferred examples for non-oxide type ceramics are carbides, nitrides, MAX phase ceramics and any other ultra-high temperature ceramics.

The reactor of the present invention might be obtained by any process known by the skilled person, such as extrusion, casting, 3D printing/additive or subtractive manufacturing, robocasting, or gel casting.

1. A gas-solid reactor body with multiple structured flow paths (channels), locally parallel to and/or perpendicular and/or at an angle to the walls of the channels, enabling substantial reduction of composition gradients along the main direction of the flow as the solid material of the reactor undergoes oxidation and reduction processes reacting with gas species carried by the flow.

2. The reactor of claim 1 wherein the solid material comprises of from about 30% to about 100% in mass fraction of mixed/doped oxides from the group:
substituted ferrites, pure mixed/doped cerium oxides, perovskites or Ruddlesden-Popper phases, and the remaining solid material of from about 0% to about 70% being a thermally resistant ceramic of the oxide type or non-oxide type.

3. The reactor of claim 1, wherein said flow paths have internal structure comprising thin porous elements with thickness of from about 0.1 mm to about 5 mm and porosity of from about 10% to about 80%

4. The reactor of claim 1 made by any of the following processes or combination of them: extrusion, casting, 3D printing/additive or subtractive manufacturing, robocasting, gel casting.

5. The reactor of claim 1 wherein one or more of the gas species is H₂O and/or CO₂.
